(19) United States
(12) Patent Application Publication
(10) Pub. No.: US 2001/0018093 A1
(43) Pub. Date: Aug. 30, 2001

(54) Method of manufacturing a circular optical storage disc and circular optical storage disc

(75) Inventor: Michel Marcel Jose Decre, Eindhoven (NL)

Correspondence Address: Corporate Patent Counsel, U.S. Philips Corporation, 580 White Plains Road, Tarrytown, NY, 10591, US

(73) Assignee: U.S. Philips Corporation

(21) Appl. No.: 09/773,131

(22) Filed: Jan. 31, 2001

(30) Foreign Application Priority Data
Feb. 25, 2000 (EP) 00200654.2

(51) Int. Cl. B05D 5/12

(52) U.S. Cl. 427/58; 427/240

(57) ABSTRACT

In the method of manufacturing a circular optical storage disc (10), an extension body (21) is present around the substrate (11) of the optical disc (10) during the spin coating of cover or spacer layers (15). The extension body (21) may consist of one or several pieces. The outer periphery (23) has a circular or polygonal shape. The inner periphery of the extension body is in close circumferential contact with the periphery (13) of the optical disc substrate (11). The surface (22) of the extension body is substantially flush with the surface (12) of the substrate (11) of the optical disc in order not to impede the flow of spin coating liquid during spin coating. The raised edge (16), which usually forms at the periphery (13) of the substrate (11) is now transferred to the outer periphery (23) of the extension body (21). After the coating operation the extension body (21) is removed. By choosing a surface (22) to which the coating (15) adheres poorly, reuse of the extension body (21) is facilitated. The manufactured optical storage disc (10) has no or a very small raised edge (16), and the method causes no extra birefringence.

The invention relates to a method of manufacturing a circular optical storage disc, having a substrate with a first surface and a periphery, wherein the first surface is provided with a coating by applying a liquid, rotating the substrate and solidifying the liquid.

The invention further relates to a circular optical storage disc manufactured by the method mentioned above.

Such a method is e.g. known from Japanese patent JP-11086356A. The said coating step is known as “spin coating”. During the process of spin coating a quantity of liquid containing a solvent is dispensed onto a substrate and the substrate is rotated. The rotational speed of the substrate is then accelerated to a higher speed, typically several hundred to thousands of rotations per minute, depending on the desired layer thickness. The centrifugal forces result in radial liquid flow so that most of the liquid is rotated off the substrate.

The laws of nature that govern the behavior of fluids results in the formation of a thicker layer of liquid, i.e. a raised edge, near the periphery of the substrate, on that keeps excess fluid from flowing. Liquid leaves the substrate in droplets, not in a continuous flow. The raised edge is the result of surface tension within the liquid and its contact angle at the periphery of the substrate. As a consequence the raised edge thickness is perturbed several millimeters inwards from the periphery of the substrate. Typically, when using a circular substrate, the distance within which perturbation occurs is of the order of several capillary length scales:

CapilaryLengthScale=\sqrt{σ/ρ.g}

where σ is the surface tension of the liquid, ρ its voluminal mass, and g the acceleration of gravity. When using an evaporating solvent the liquid starts to solidify rapidly due to evaporation of the solvent, leaving a solid coating with a certain radial thickness profile which has circular symmetry. Usually a thermal curing step follows this process step for further solidification. When a non- or slowly evaporating solvent is used, the liquid material usually is UV curable and is cured for solidification directly after the spin-coating step with the substrate still present in its spin coating position.

In the method described in JP-11086356A an oversized substrate is used, which is cut to the desired diameter with a special tool after spin coating and solidification of the liquid, thus removing the raised edge.

A disadvantage of this method is that a special tool is required to trim the substrate and that particles, dust or flakes, which pollute the surface of the optical disc, may be formed by the trimming operation. Furthermore, these tools are subject to wear and need frequent replacement.

Another disadvantage is that the trimming operation may cause non-relaxed strain in the substrate near the cut edge which can generate optical birefringence in a peripherical zone of a few mm, e.g. 5 mm, of the substrate which may cause problems when the optical disc is written or read out through the substrate.

Yet another disadvantage is that a non-standard oversized substrate, which is more expensive to produce, is used in the manufacture of the optical disc.

It is an object of the invention to provide a method of the kind described in the opening paragraph by means of which the occurrence of a raised edge on the disc is counteracted while trimming of the substrate is avoided.

This object of the invention is achieved in that

when applying the liquid onto the first surface, the substrate is present in a separate extension body having substantially circumferentially contact with the periphery of the substrate and having a surface substantially flush with the first surface of the substrate, and

after at least partial solidification of the liquid, the extension body and the substrate are separated.

The extension body forms a substantially continuous surface with the first surface of the optical disc substrate. The surface of the extension body preferably does not extend beyond the first surface of the substrate. In practice, a very slight deviation of less than one tenth of the desired coating thickness may be acceptable. In this case the flow of coating liquid off the substrate is not or hardly impeded by the extension body. The surface of the extension body may be positioned slightly below the first surface of the substrate, e.g. at a distance of up to about one third of the desired coating thickness, but preferably any deviation should be avoided. Thus, the formation of a raised edge is eliminated since the coating liquid smoothly crosses the substrate-extension body boundary. The raised edge is transferred from the optical disc substrate periphery to the outer periphery of the extension body.

It is very important that the extension body contacts the outer periphery of the substrate of the optical disc substantially circumferentially, thus avoiding chinks between the extension body and the substrate. Otherwise surface tension may cause deviations in layer thickness, and even a raised edge, at the position of the chinks. The absence of a chink also prevents capillary flow of liquid through said chink. Although avoiding a chink is important, in practice, a very small chink which does not cause substantial capillary flow of coating liquid may be present and acceptable.

The shape of the extension body below its surface can be chosen freely as long as its surface is substantially flush with the first surface of the optical disc substrate and chinks are avoided between the optical disc substrate and the extension body. When after solidification of the liquid the extension body is removed, this either causes the coating to break off at the periphery of the substrate of the optical disc or to be released from the extension body. The adhesion property of the surface of the extension body determines which of the two possibilities occurs. When the coating is fully released from the extension body and still forms one whole with the coating on the substrate of the optical disc, it is necessary to remove the overhanging part. This, however, only requires a very simple cutting tool because of the relatively small layer thickness of the coating.

In an embodiment of the method of the invention, the extension body has an outer periphery which has a circular shape. Such an extension body is relatively easy to fabricate because of its circular shape.

In another embodiment of the method of the invention, the extension body has an outer periphery which has a polygonal shape. In this embodiment, the raised edge perturbation distance is substantially reduced and the counteraction of the formation of a raised edge near the periphery of the substrate of the optical disc is further improved. An explanation for this improvement is the improved drainage of coating liquid due to the presence of corner points at the periphery of the extension body. The amount of excess liquid and thus the potential heigth and width of a raised edge is reduced.

In a modification of this embodiment of the method of the invention, the extension body has a regular polygonal shape, e.g. hexagonal or square, which has the advantage of a symmetrical drainage of liquid. Another advantage is that a balanced disc/extension body combination, which is important during rotation of said combination, is easily realized. Yet another advantage is that hexagonal and square extension bodies can be cut from plate material without substantial cutting losses.

In an embodiment of the method of the invention, the extension body consists of the same material as the optical disc substrate. In this case the solidified liquid adheres relatively well to the surface of the extension body, so that the extension body generally cannot be reused in the manufacture of a subsequent disc, unless e.g. the extension body is positioned lower than before.

The surface of the extension body may, however, consist of a material to which the solidified liquid adheres relatively poorly. This has the advantage that the solidified liquid may be released from the extension body, e.g. when the disc and the extension body are separated, so that the extension body can easily be used again.

In another embodiment, the extension body is composed of at least two parts with surfaces substantially flush with the first surface of the substrate. The advantage is that the placing in position around the optical disc substrate of the parts of the extension body can be automated more easily, which is favourable in a mass production environment. In this embodiment it is favourable to use parts with surfaces to which the solidified liquid adheres relatively poorly. When for example the parts of the extension body are removed in a downward and radially outward direction with respect to the optical disc substrate the solidified liquid easily becomes detached from the surface of the parts of the extension body, leaving it ready for the manufacture of a next optical disc. In this manner it is avoided that solidified liquid residues are left behind on the surfaces of the parts.

It is favourable when the liquid is solidified by exposure to UV light. When thick solidified layers are desired, for example 50-150 micrometers, this measure has the advantage of a relatively fast solidification when using liquids containing a non- or slowly-evaporating solvent.

Using the method according to the invention, a circular optical disc can be manufactured with a substrate which is substantially free from optical birefringence in the peripherical zone. This can be explained by the fact that, unlike the above cited known method according to the present invention trimming of the coated substrate is not required to remove the part of solidified liquid which mainly comprises the raised edge.

The coating may be a cover or a spacer layer and has a reduced thickness variability on an optical disc substrate, thereby improving the optical read and write performance in underlying recording layers when the read or write beam passes through said cover or spacer layer. For instance a 100 μm cover layer is used for the new 60 mm radius Digital Video Recording (DVR) disc. This disc is written and read out through this cover layer, which therefore has to be of good optical quality. According to the current standardization discussions, the cover layer has to be 100+30/−3 μm thick up to a radius 58.5 of mm and in the ring from a radius of 58.5 mm to a radius of 60 mm the thickness must not vary more than 50 μm.

Spacer layers are used in multilayer optical recording discs in which several recording layers are separated by such a spacer layer. Mostly these spacer layers have a thickness of the order of tens of micrometers and should not vary more then about 5 percent in thickness.

The accompanying schematic drawings illustrate embodiments of the method of the invention and together with the description serve to explain the principles of the method of the invention. In the drawings:

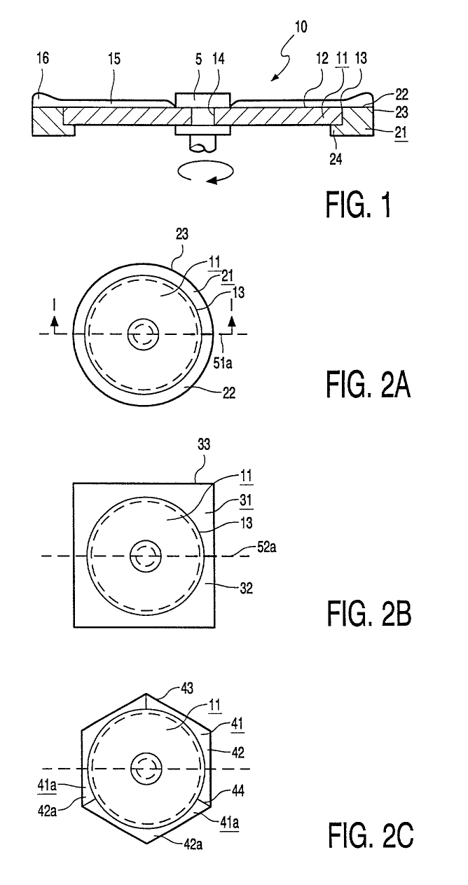

FIG. 1 is a cross sectional view taken along the line I-I in FIG. 2A; of a spin coating chuck holding an optical disc substrate surrounded by an extension body and covered with a coating.

FIG. 2A is a top view of the assembly of FIG. 1;

FIG. 2B is a modification of FIG. 2 A wherein the outer periphery of the extension body is polygonal;

FIG. 2C is a further modification of FIG. 2 A wherein the outer periphery of the extension body is polygonal and the extension body comprises three parts;

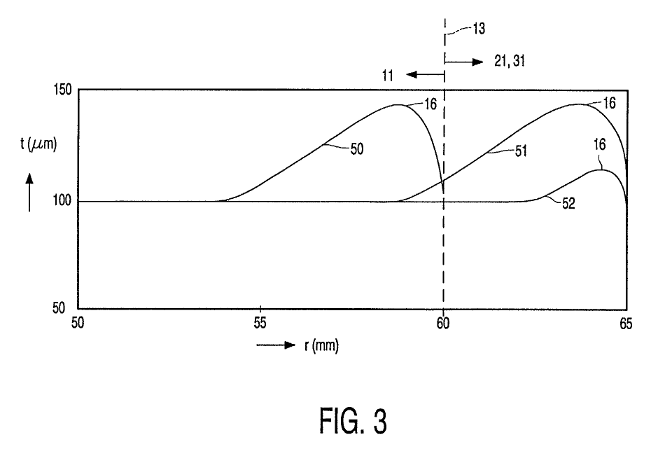

FIG. 3 shows three thickness profiles of a coating, two of which are applied by using the method of the invention.

Referring to FIG. 1 and FIG. 2A, the circular optical disc substrate 11 has a central hole 14 and a circular periphery 13. The central hole 14 permits the substrate 11 to be mounted on a spin coating chuck 5 and permits the manufactured optical disc 10 to be centered in an optical disc player or recorder. On the substrate 11 there may already have been deposited a data reading or recording layer stack and a tracking structure of the kind which is used e.g. in state of the art optical recording media. In accordance with the invention, the substrate 11 is present in a separate extension body 21 with a surface 22. A coating 15 is provided onto a first surface 12 and the surface 22. For example, this can be accomplished by depositing a liquid outside the central chuck 5 using a nozzle, while the substrate/extension body combination 11, 21 is rotating at a low speed of about 30 rpm, and moving the dosing nozzle gradually towards the outside. In this way the first surface 12 can be covered with the coating 15.

The extension body 21 is substantially circumferentially in contact with the periphery 13 of the substrate 11. The surface 22 of the extension body is substantially flush with the surface 12 of the optical disc substrate 11.

Once the coating liquid, e.g. a quantity of 10 ml of UV curable resin Daicure SD645, is deposited the rotational speed of the substrate 11 and the extension body 21 is increased to 220 rpm and maintained at this speed during 66 sec. Because of the rotation speed most of the coating liquid is driven off the surfaces 12, 22 of the substrate 11 and extension body 21 via the outer periphery 23 leaving a relatively thin layer of about 100 μm. Due to surface tension of the liquid, a raised edge 16 has been formed near the outer periphery 23 of the extension body 21. This raised edge has a substantially larger liquid layer height than the liquid layer height on the covered substrate 11. The typical width of such a raised edge 16 is in the order of several millimeters, depending on the physical properties of the coating liquid and the surface 12, 22 on which it is deposited. Because the raised edge 16 is formed on the surface of the extension body 21, the height of the coating 15 on the optical disc substrate 11 is not or only slightly increased.

Once the rotation has stopped, the liquid layer is solidified by exposure to UV light during 6 sec using a high power UV source (Philips HP-A 400W) with a special reflector at a height of 18 cm above the liquid surface. This is all carried out in a nitrogen atmosphere. Hereafter the extension body 21 is removed. This can be done by moving down the extension body 21 relatively to the optical disc substrate 11. In this manner, the part of coating 15 which covers the surface 22 of the extension body 21 either breaks off at the periphery 13 of the substrate 11 of the optical disc or is released from the extension body 21. The adhesion property of the surface 22 of the extension body 21 determines which of the two possibilities occurs. The material of the surface 22 of the extension body 21 can be the same as the material of the optical disc substrate 11, which may cause a relatively good adhesion of the solidified coating. For a low adhesion, the surface 22 of the extension body 21 should have a low surface energy. This can be achieved by selecting a low adhesion bulk material, or by a surface treatment of the extension body 21. Possibilities are:

Bulk material: Fluor-polymers, aliphatic polymers and/or aromatic (e.g. parylene) and the like.

Surface treatment: Silanes with hydrophobic groups, e.g. Octadecyl-trichloro-silane, CₙF₂ₙ₊₁(CH₂)₂SiX₃, in which X may be Cl, OCH₃, OC₂H₅ and 6<n<12.

If the shape of the extension body 21 is such that it can be moved upwards with respect to the substrate 11 of the optical disc 10, e.g. when the inner part 24 of the extension body 21 is not present, the part of the coating 15 containing the raised edge 16 is more likely to break off at the periphery 13 even if the adhesion to the surface 22 of the extension body 21 is poor.

In case the outer part of the coating 15 is fully released from the extension body 21, and still forms an integral layer with the coating 15 on the substrate 11 of the optical disc 10, there is an overhanging part. This part can be removed with a very simple cutting tool because of the relatively small layer thickness of the coating 15. The extension body 21 has an inner diameter of 120 mm and an outer diameter of 130 mm.

Referring to FIG. 2B, the optical disc substrate 11 is present in an extension body 31 with a polygonal outer periphery 33. The extension body 31 shown has a square outer periphery 33 with a side dimension of 130 mm.

Referring to FIG. 2C, an equivalent optical disc substrate 11 is surrounded by three congruent extension body parts 41a. The parts 41a are positioned in such a way that there is substantially circumferential contact with the periphery 13 of the optical disc substrate 11, and the surfaces 42a of the parts 41a are substantially flush with the first surface 12 of the substrate 11. In this arrangement, the outer periphery 43 of the three parts 41a has the shape of a regular hexagon of which two parallel sides are a distance of 130 mm apart. The surfaces 42a of the extension body parts 41 a preferably have a property which causes a low adhesion of the coating 15. Possibilities to achieve this are mentioned in the description of FIG. 1. Once the liquid has solidified the parts 41a can be moved radially outwards. This movement causes the coating 15 to be released from the surface 42a of the parts 41a. The remaining coating can be removed as mentioned in the description of FIG. 1.

Referring to FIG. 3, three graphs are shown of the thickness of the coating 15 on the optical disc substrate 11 in the range from 50 mm radius to 60 mm radius and on the extension body 21, 31 in the range from 60 to 65 mm radius. The latter only if applicable. The range below radius 50 mm is not shown because the influence of a raised edge is not substantially present in this range.

r=distance to the center of an optical disc substrate in mm.

t=thickness of the coating on an optical disc substrate or extension body in micrometers.

Graph 50 represents the thickness profile of a coating 15 provided on an optical disc substrate 11 without using an extension body.

Graph 51 represents the thickness profile of a coating 15, measured along dotted line 51a, provided on an optical disc substrate 11 using the extension body 21 as shown in FIG. 2A.

Graph 52 represents the thickness profile of a coating 15, measured along dotted line 52a, provided on an optical disc substrate 11 using the extension body 31 as shown in FIG. 2B.

As can be seen from graph 50 a substantial raised edge 16 is present between a radius of 54 and 60 mm when no extension body is used.

In graph 51, when using an extension body 21 with a circular outer periphery 23 and a diameter of 130 mm, the raised edge 16 is mainly present on the extension body 21. However, due to the relatively large perturbation distance of the raised edge 16, still some effect of the raised edge 16 is present just within a radius of 60 mm of the optical disc substrate 11.

In graph 52, when using an extension body 31 with a square outer periphery 33 and a side size of 130 mm, the raised edge 16 perturbation distance is substantially reduced and no effect of raised edge 16 is visible anymore within a radius of 60 mm of the optical disc substrate 11. As already explained before this is due to extra drainage of excess liquid at the corners of the periphery 33 during rotation of the substrate/extension body combination 11, 31 after depositing the liquid.

1. A method of manufacturing a circular optical storage disc (10) having a substrate (11) with a first surface (12) and a periphery (13), wherein the first surface (12) is provided with a coating (15) by applying a liquid, rotating the substrate, and solidifying the liquid, characterized in that:
when applying the liquid onto the first surface (12), the substrate (11) is present in a separate extension body (21, 31, 41)
having substantially circumferentially contact with the periphery (13) of the substrate (11) and
having a surface (22) substantially flush with the first surface (12) of the substrate (11), and
after at least partial solidification of the liquid, the extension body (21, 31, 41) and the substrate (11) are separated.

2. A method as claimed in claim 1, characterized in that said extension body (21) has an outer periphery (23) which has a circular shape.

3. A method as claimed in claim 1, characterized in that said extension body (31) has an outer periphery (33) which has a polygonal shape.

4. A method as claimed in claim 3, characterized in that said extension body (31) has an outer periphery (33) which has a regular polygonal shape.

5. A method as claimed in claim 1, 2 or 3, characterized in that the surface (22, 32, 42) of the extension body (21, 31, 41) consists of substantially the same material as the substrate (11) of the optical storage disc (10).

6. A method as claimed in claim 1, 2 or 3, characterized in that the surface (22, 32, 42) of the extension body (21, 31, 41) consists of a material to which the coating (15) adheres relatively poorly.

7. A method as claimed in claim 1, characterized in that said extension body (41) is composed of at least two parts (41a) with surfaces (42a) substantially flush with the first surface (12) of the substrate (11).

8. A method as claimed in claim 1, characterized in that the liquid is solidified by exposure to UV light.

9. A circular optical disc (10) manufactured by the method as claimed in claim 1 characterized in that the substrate (11) is substantially free from optical birefringence in a few mm broad peripherical zone.
